(19) United States
(12) Patent Application Publication
(10) Pub. No.: US 2005/0040617 A1
(43) Pub. Date: Feb. 24, 2005

(54) Safety device for service cart on passenger airplane

(75) Inventor: Hiroyuki Terada, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN AEROSPACE EXPLORATION AGENCY, Chofu-shi (JP)

(21) Appl. No.: 10/795,262

(22) Filed: Mar. 9, 2004

(30) Foreign Application Priority Data
Aug. 19, 2003 (JP) 2003-207845

(51) Int. Cl. B62B 3/00

(52) U.S. Cl. 280/47.34

(57) ABSTRACT

An object of the present invention is to provide a system that ensures safety when an airframe makes a sudden and sharp vertical movement, the system operating automatically to restrain movement of a service cart in a vertical direction such that the workload of a cabin attendant is not increased and there is no need for structural design modifications of the airframe. The safety device for a service cart of the present invention is designed to prevent the cart from floating upward by engaging a part of the cart with a fitting on the passenger seat, and comprises a sensor constituted by a combination of an inertial member and a spring to detect a sudden vertical motion of the airframe and a mechanism which causes plates to protrude from both the left and right sides of the cart using a detection signal of the sensor as a trigger. The protruding plates are then engaged.

### BACKGROUND OF THE INVENTION

1. Field of the Invention

The present invention relates to a safety device for a service cart which is operated when the airframe of a passenger airplane is greatly displaced by air current fluctuations or the like.

2. Description of the Related Art

At present, carts used for onboard services in passenger airplanes are provided with no safety devices other than a brake pedal for preventing the casters from rotating so that the cart does not move in the direction of movement during service. While in operation, however, aircraft often encounter sudden fluctuations in vertical acceleration due to turbulence or urgent action taken to avoid a collision. This acceleration is sometimes negative, causing the cabin attendant or service cart to rise into the air, and as a result, the cabin attendant may be injured or killed if s/he hits the ceiling, or a passenger may be seriously injured or killed if struck violently by the service cart. In current carts, no measures whatsoever have been taken to deal with such variation in acceleration in a vertical direction, and hence there is a high demand from cabin attendants for safety measures. The research institute of the present applicants, together with the Japanese Ministry of Land, Infrastructure, and Transport and various air carriers, have undertaken continuing investigations into safety measures for preventing such accidents, but at present, a passenger airplane which employs specific safety measures has yet to be realized either in Japan or overseas.

A service cart is used to provide food and drinks to passengers, or is circulated through the passenger seats by a cabin attendant during in-flight sales, and hence is an essential piece of equipment on a passenger airplane. Services are provided while the service cart is moved through aisles between the passenger seats, and hence it has often been considered a good idea to employ a constitution whereby the wagon of the cart is held on both sides by rails such that the cart is fixed to the floor with stability even when the airframe makes a sudden vertical motion. Since the tracks required for this would be provided in the aisles, however, the tracks must be constituted as rails which are buried in the floor so that people do not trip. Accordingly, the floor of the airframe must be re-covered, and hence air carriers are unlikely to employ such a measure due to cost considerations. Moreover, support poles for supporting the wagon of the cart must be extended below the floor, and hence groove portions must be provided in the floor. By providing groove openings in the floor surface, the probability of objects falling into the openings and becoming stuck increases, numerous problems arise in regard to maintenance, concerns of high-heeled shoes becoming trapped and so on increase, and hence employment of such a constitution is somewhat difficult.

### SUMMARY OF THE INVENTION

An object of the present invention is to provide a system that ensures safety when an airframe makes a sudden and sharp vertical movement, the system operating automatically to restrain movement of a service cart in a vertical direction such that the workload of a cabin attendant is not increased and there is no need for structural design modifications to the airframe.

The safety device for a service cart of the present invention is designed to prevent the cart from floating upward by engaging a part of the cart with a fitting on the passenger seat, and comprises a sensor constituted by a combination of an inertial member and a spring to detect a sudden vertical motion of the airframe and a mechanism which causes plates to protrude from both the left and right sides of the cart using a detection signal of the sensor as a trigger. The protruding plates are then engaged.

As a specific example of the sensor configuration, a constitution is proposed in which an axle bearing is provided on the bottom portion of the cart, a spring is fixed thereto, and a wheel is attached to the other end portion of the spring via an axle, thus providing a switch which operates in response to relative displacement between the axle bearing and axle.

As a specific example of the mechanism for causing the plates to protrude, a constitution comprising a spring which urges the plates in a protruding direction, a member which latches the plates against the urging force of the spring such that the plates are pushed within the width of the cart, and an electromagnetic mechanism for removing the latch of the latch member when a detection signal from the sensor acts on the electromagnetic mechanism is proposed.

Further, as a specific example of a mechanism for returning the plates from a protruded state to their original state and maintaining the original state, a constitution is proposed in which the urging force of a spring acts on the latch member such that when the protruding plates are pushed within the width of the cart and no detection signal is received by the electromagnetic mechanism, the force of the spring causes the plate to engage with the latch member.

### BRIEF DESCRIPTION OF THE DRAWINGS

FIG. 1 is a view illustrating an operation of a safety device for a service cart on a passenger airplane according to the present invention;

FIG. 2 is a view illustrating an operation in which a sensor detects a sudden vertical motion in an embodiment; and

FIG. 3 is a view illustrating an operation in which a plate is caused to protrude using a detection signal as a trigger and an operation in which the plate is returned to its original state in an embodiment.

### DESCRIPTION OF THE PREFERRED EMBODIMENTS

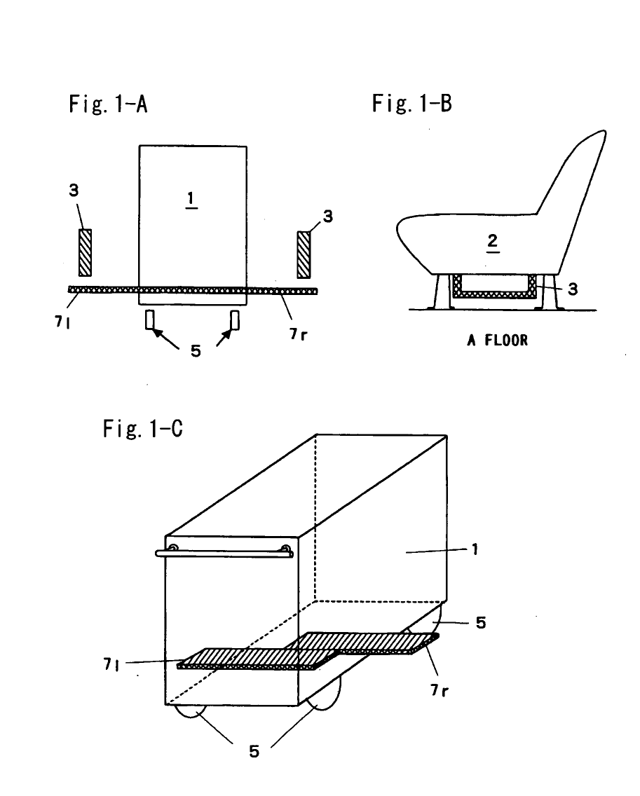

The present invention is effective not only during turbulence, but also during unpredictable and highly dangerous clear air turbulence (CAT). The present invention also responds automatically to negative gravitational acceleration (-G), and has been developed with the aim of securing safety by restraining vertical motion without increasing the workload on a cabin attendant or requiring structural design modifications of the airframe. The basic premise of the service cart safety device of the present invention is such that when negative gravitational acceleration takes effect, a part of the cart engages with a fitting on the passenger seat as shown in FIG. 1-A and FIG. 1-B, thus preventing the cart from floating upward. Note that, for a part of the cart to engage with the fitting on the passenger seat, the member which constitutes that part must protrude outward of the width of the cart as shown in the perspective view in FIG. 1-C. However, the service cart is used while being pushed through the aisles between the passenger seats, and hence if the member protrudes outward of the width of the cart, the member causes an obstruction during movement, and may cause a person to trip when passing through the aisle. Hence, the employment of a constitution was considered in which during normal operations, the member is accommodated within the width of the cart, such that the member protrudes only when negative gravitational acceleration that may cause the cart to float upward takes effect, or in conditions approaching such negative gravitational acceleration (0G or low G). However, having a cabin attendant perform this operation during service places a heavy load on the cabin attendant, and moreover, in reality it would be extremely difficult to react in a split second to such momentary changes in condition. It was therefore decided to provide a sensor for detecting a sudden vertical motion of the airframe, which is constituted by a combination of an inertial member and a spring, and a mechanism which uses a detection signal from this sensor as a trigger to cause engaging members to protrude from both the left and right sides of the cart. By employing such a constitution, a function is provided to cause the member which is accommodated within the width of the cart during normal operations to protrude in rapid response to an emergency. As for the structure of this member, a plate constitution is employed whereby the plates engage widely with fitting plates serving as engaging partners on the passenger seats. By obtaining a wide surface contact, both upward floating and rotary motion can be prevented.

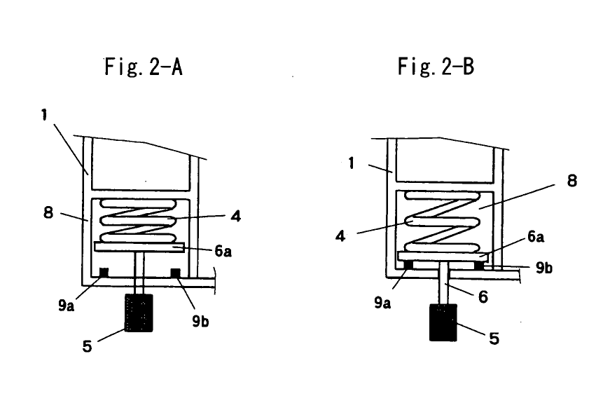

Embodiments for substantiating the present invention will now be described. First, a sensor constituted by a combination of an inertial member and a spring to detect a sudden vertical motion of the airframe is provided. In this embodiment, the inertial member is the cart itself, and the spring is a spring which supports the axle of the cart. As shown in FIG. 2, an axle bearing 8 is provided in the bottom portion of a cart 1, one end of a spring 4 is fixed to the upper surface of the axle bearing 8, and a wheel 5 fixed with an axle 6 is attached to the other end portion of the spring 4 via a conductive substrate 6a. During normal operations, when no irregular acceleration in a vertical direction is made and gravitational acceleration of approximately 0.5G to 1G, for example, is in effect, the spring 4 is compressed by the deadweight of the loaded cart as shown in FIG. 2-A, and hence the substrate 6a is removed from the lower surface of the axle bearing 8. However, when a large downward acceleration occurs in the airframe, the deadweight of the loaded cart becomes artificially lighter, and hence the force of the spring 4 causes the substrate 6a to press against the lower surface of the axle bearing 8 as shown in FIG. 2-B. As shown in the drawings, contacts 9a, 9b are provided on the lower surface of the axle bearing 8. During normal operations, as shown in FIG. 2-A, the contacts 9a, 9b are opened, but when negative gravitational acceleration occurs in the airframe, the contacts 9a, 9b are closed as shown in FIG. 2-B. This forms a switch which operates in reaction to relative displacement between the axle bearing 8 and axle 6. The magnitude of the downward acceleration that causes the switch to operate corresponds to the modulus of elasticity of the spring, and is therefore determined as a value during the design process.

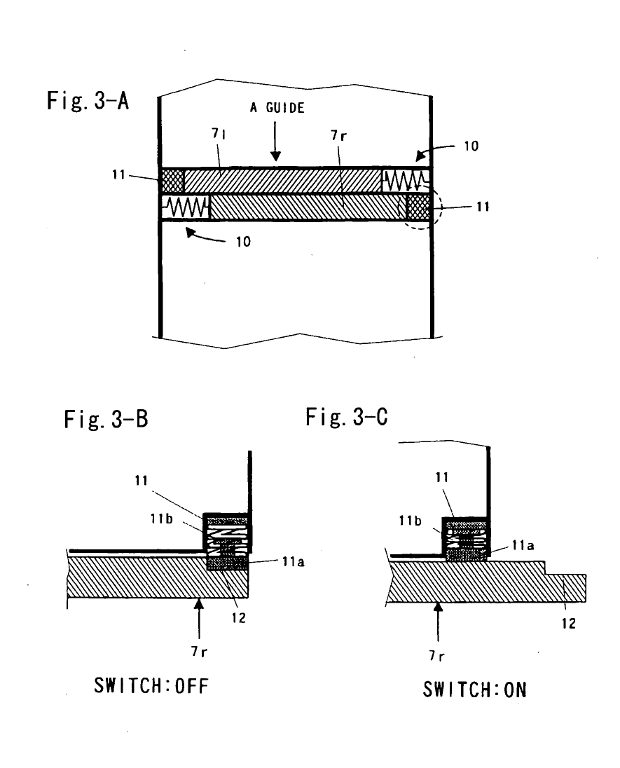

In this embodiment, the mechanism for causing the plates to protrude is constituted by a spring which urges the plates in a protruding direction, a member which latches the plates against the urging force of the spring such that the plates are pushed within the width of the cart, and an electromagnetic mechanism for removing the latch of the latch member. As shown in FIG. 3-A, two plates 7l, 7r having shorter dimensions than the width of the cart 1 are attached to the bottom central portion of the cart 1 so as to be capable of sliding in the direction of width along a guide member 9. The reason for setting the attachment position in the bottom central portion of the cart 1 is to prevent upward floating by setting the attachment position on the vertical line from the center of gravity of the cart, efficiently. Ejection springs 10 are interposed between the opposite end portion of the plates 7l, 7r to the end portion which protrudes in order to be engaged and the side walls of the cart 1, and these springs 10 urge the respective plates 7l, 7r to protrude. As shown in FIG. 3-B and FIG. 3-C, which illustrate enlarged sectional views of the vicinity of an electromagnetic mechanism 11, surrounded by a broken-line circle in FIG. 3-A, latching stepped portions 7a are provided in the plates 7l, 7r. As shown in FIG. 3-B, during a normal operation, a latch member 11a engages with the stepped portion 7a to prevent the plates 7l, 7r from protruding outward of the width of the cart. However, when a negative gravitational acceleration occurs in the airframe, the contacts 9a and 9b are closed as described above, and a resulting switch ON signal causes an electric current to be supplied to the electromagnetic mechanism 11. As a result, as shown in FIG. 3-C, the latch member 11a is pulled upward by electromagnetic force, thereby releasing the engagement with the stepped portion 7a, and thus the force of the ejection spring 10 causes the two plates 7l, 7r to protrude to the left and right instantaneously. The two plates 7l, 7r protruding to the left and right as a result of this action become engaged with fittings 3 on the passenger seat 2, and the cart 1 is prevented from floating upward.

If the end portions of the two plates 7l, 7r which are caused to protrude to the left and right upon detection of a large downward acceleration (in the condition shown in FIG. 3-C) are pushed back into the cart manually by the cabin attendant against the urging force of the ejection spring 10, the electric current to the electromagnetic mechanism 11 is cut, and the latch member 11a, on which no upward-lifting force is now acting, receives the pressing force of a return spring 11b. Thus the latch member 11a is pressed back into the position of the stepped portion 7a and engages therewith so as to return to the condition shown in FIG. 3-B. Hence, the end portions of the plates are latched such that even when the cabin attendant removes the hand which pushed the plates back in, the urging force of the ejection spring 10 is prevented from causing the plates to protrude. Accordingly, in this embodiment the operation for returning to the original state can be executed extremely easily.

Note that when the service cart 1 is not in use, the safety device of the present invention should be kept inoperative by switching the power switch OFF such that the electromagnetic mechanism 11, for example, is not energized.

The service cart safety device of the present invention is constituted by a sensor for detecting a sudden vertical motion of the airframe, which is constituted by a combination of an inertial member and a spring, and a mechanism for causing plates to protrude from both the left and right sides of the cart using a detection signal of the sensor as a trigger. Hence, when a sudden vertical motion is detected in the airframe, a portion of the cart engages with a fitting on the passenger seat, and as a result, the onboard service cart can be reliably prevented from floating upward in reaction to various types of turbulence, urgent operations, and so on encountered in a passenger airplane in such a manner that virtually no rotation or vertical motion occurs. Moreover, by securing the cart, death or injury to cabin attendants, and death or injury to passengers caused by a falling cart, can be prevented. Furthermore, preventing the cart from floating upward requires no reconstruction of the cabin floor structure or the like and places no extra workload on the cabin attendants.

In the service cart safety device of the present invention, which employs a sensor configuration in which an axle bearing is provided on the bottom portion of the cart, a spring is fixed thereto, and a wheel is attached to the other end portion of the spring via an axle, thus providing a switch which operates in response to relative displacement between the axle bearing and axle, the cart itself functions as an inertial member, and hence the safety device functions as a sensor for detecting a sudden vertical motion of the airframe by means of an extremely simple constitution.

Further, in the service cart safety device of the present invention, a mechanism for causing the plates to protrude is constituted by a spring which urges the plates in a protruding direction, a member which latches the plates against the urging force of the spring such that the plates are pushed within the width of the cart, and an electromagnetic mechanism for removing the latch of the latch member when a detection signal from the sensor acts on the electromagnetic mechanism, and thus the protrusion operation can be executed on the plates instantaneously while maintaining a simple constitution.

Further, in the service cart safety device of the present invention, a mechanism for returning the plates from a protruded state to their original state and maintaining the original state is constituted such that the urging force of a spring acts on a latch member, and hence when the protruding plates are pushed within the width of the cart and no detection signal is received by the electromagnetic mechanism, the force of the spring causes the plates to engage with the latch member. Thus the protruding plates can be securely returned to their original state by means of a simple pushing operation performed by a cabin attendant.

1. A safety device for a service cart comprising:
a sensor constituted by a combination of an inertial member and a spring to detect a sudden vertical motion of an airframe; and
a mechanism for causing plates to protrude from both the left and right sides of the cart using a detection signal from said sensor as a trigger,
wherein the cart is prevented from floating upward by causing said plates to protrude and then engaging said plates with a fitting on a passenger seat.

2. The safety device for a service cart according to claim 1, wherein said sensor configuration is constituted by providing an axle bearing on the bottom portion of the cart, fixing a spring thereto, and attaching a wheel to the other end portion of said spring via an axle, thus providing a switch which operates in response to relative displacement between said axle bearing and said axle, and
the cart itself functions as said inertial member.

3. The safety device for a service cart according to claim 1, wherein said mechanism for causing the plates to protrude is constituted by a spring for urging the plates in a protruding direction, a member which latches said plates against the urging force of said spring such that said plates are pushed within the width of the cart, and an electromagnetic mechanism for removing the latch of said latch member, such that when a detection signal from the sensor acts on said electromagnetic mechanism, said detection signal acts as a trigger to release the engagement and cause the plates to protrude.

4. The safety device for a service cart according to claim 2, wherein said mechanism for causing the plates to protrude is constituted by a spring for urging the plates in a protruding direction, a member which latches said plates against the urging force of said spring such that said plates are pushed within the width of the cart, and an electromagnetic mechanism for removing the latch of said latch member, such that when a detection signal from the sensor acts on said electromagnetic mechanism, said detection signal acts as a trigger to release the engagement and cause the plates to protrude.

5. The safety device for a service cart according to claim 3, wherein the latch member is a structure on which the urging force of a spring acts, such that when the protruding plates are pushed within the width of the cart and no detection signal is received by the electromagnetic mechanism, the force of said spring causes said plates to engage with said latch member, whereby said plates return to the original state thereof and are maintained in this original state.

6. The safety device for a service cart according to claim 4, wherein the latch member is a structure on which the urging force of a spring acts, such that when the protruding plates are pushed within the width of the cart and no detection signal is received by the electromagnetic mechanism, the force of said spring causes said plates to engage with said latch member, whereby said plates return to the original state thereof and are maintained in this original state.
